(19) United States
(12) Patent Application Publication
(10) Pub. No.: US 2025/0003035 A1
(43) Pub. Date: Jan. 2, 2025

(54) REFRACTORY METAL COMPONENT

(71) Applicant: PLANSEE SE, Reutte (AT)

(72) Inventors: Gerhard Leichtfried, Reutte (AT); Lukas Kaserer, Innsbruck (AT); Jakob Braun, Innsbruck (AT); Heinrich Kestler, Reutte (AT)

(21) Appl. No.: 18/707,663

(22) PCT Filed: Nov. 3, 2022
(86) PCT No.: PCT/AT2022/060376

§ 371 Date: May 6, 2024

(30) Foreign Application Priority Data
Nov. 4, 2021 (AT) GM 50225/2021

(51) Int. Cl. C22C 27/04; B22F 10/28; B33Y 10/00; B33Y 70/00; B33Y 80/00

(52) U.S. Cl. CPC C22C 27/04; B22F 10/28; B33Y 10/00; B33Y 70/00; B33Y 80/00

(57) ABSTRACT

A component having a solid structure of an alloy which, as a main component, contains a refractory metal (RM) from the group of molybdenum and tungsten and, as a further component, boron (B) and optionally carbon (C). The solid structure is manufactured additively by laser beam or electron beam, and the solid structure has regions made of the RM or a mixed crystal of the RM and the regions are at least partially delimited by (RM)₂B, where B in (RM)₂B can be partially replaced by C.

The invention relates to a component having a solid structure consisting of an alloy which comprises as a main component a refractory metal (referred to for short as “RM” in the present disclosure) from the group of molybdenum and tungsten and as a further component boron and optionally carbon, to an additive manufacturing process for producing a component, to a powder for an additive manufacturing process, and to a use of a powder for an additive manufacturing process.

Because of the high melting point, low coefficient of thermal expansion and high thermal conductivity, molybdenum (Mo), tungsten (W) and alloys thereof are used for various high-performance applications, as for example for X-ray anodes, heat sinks, high-temperature heating zones, thrusters, extrusion dies, mold parts for injection molds, hot runner nozzles, resistance welding electrodes or components for ion implantation systems. These elements, moreover, have a high density, thus ensuring good shielding behavior with respect to electromagnetic and particle radiation. As a result of the comparatively low ductility at room temperature and the high DBTT (ductile-brittle transition temperature), the processing characteristics are disadvantageous for both machining and forming processes. Furthermore, with the exception of molybdenum-rhenium and tungsten-rhenium, the weldability of these materials is poor. One industrial-scale process for producing components from these materials is the powder metallurgical production route, in which corresponding starting powders are pressed and sintered and in general subjected subsequently to forming at high temperature (temperature above DBTT).

The possibilities for geometric component design that are achievable with additive manufacturing processes far exceed those of conventional processes. Especially for materials such as molybdenum, tungsten and alloys thereof, the additive manufacturing process is especially advantageous since, compared to other metallic materials, these materials are markedly more difficult to process with commonly used conventional manufacturing methods. Beam-based additive manufacturing of metallic materials usually employs powders, and less commonly also wires, as starting material. Metallic materials have seen the establishment of a number of procedures, such as selective laser beam melting (SLM) and selective electron beam melting (SEBM), in which powder applied layer-wise is locally melted, and laser metal deposition (LMD), in which a powder supplied via a nozzle is melted. Additive manufacturing processes do not require machining or forming tools, thus allowing cost-efficient manufacturing of components in a low number of units. Moreover, component geometries can be realized that for conventional manufacturing processes are producible, if at all, only at very high cost and complexity. Furthermore, a high resource efficiency is achieved, since powder particles that have not fused or sintered together can be reused. A disadvantage of these processes presently remains the very low build rate.

It must be taken into account in beam-based additive manufacturing processes, moreover, that compared to conventional consolidation processes, such as casting or sintering, different metal-physical mechanisms are in effect. While it is surface and grain boundary diffusion that determine densification in the case of sintering, the mechanisms of action in processes comprising local melting and solidification at high cooling rate, such as SLM, SEBM and LMD, are different, much more complex and also not yet completely understood. Mention may be made here of wetting characteristics, Marangoni convection, recoil effects due to evaporation, segregation, epitaxial grain growth, solidification time, heat flow, heat flow direction and internal stresses as a result of solidification shrinkage. Materials concepts that are successful in conventional processes usually do not lead to defect-free components in beam-based additive processes.

Production of pure tungsten and pure molybdenum by selective laser melting is described in a specialist article by J. Braun et al. (“Molybdenum and tungsten manufactured by selective laser melting: Analysis of defect structure and solidification mechanisms.” International Journal of Refractory Metals and Hard Materials 84 (2019): 104999, https://doi.org/10.1016/j.ijrmhm.2019.104999).

The most widespread additive manufacturing process is the selective laser beam melting process. It involves using a coater to apply a powder layer to a substrate. A laser beam is then guided over this powder layer. The beam performs local melting of the powder particles, so causing the individual powder particles to fuse to one another and to the previously applied layer. A layer of the component to be manufactured is thus formed through successive local melting of powder particles and subsequent solidification. A further powder layer is then applied to the previously processed powder layer and the process recommences. The component is thus constructed further with each new powder layer, with the build direction being perpendicular to the respective planes of the powder layers. Since the additive manufacturing procedure results in a characteristic microstructure, the skilled person is able to discern whether a component has been produced by a conventional procedure or by an additive procedure.

Molybdenum and tungsten have a high melting point, a high thermal conductivity in the solid phase, and a high surface tension and viscosity in the liquid phase. These materials are among the most difficult materials that can be processed by an additive manufacturing process. The short time in the molten phase caused by the high thermal conductivity, combined with the high surface tension and high viscosity, favor the balling effect, which in turn leads to pores and thus to crack-inducing defects and a low density. The balling effect is also detrimental to surface quality, specifically to surface roughness. Since molybdenum and tungsten have a very low fracture toughness, local defects combined with the internal thermally induced stresses that are inherent in the process lead to cracks.

Components made of molybdenum and tungsten and produced by selective laser or electron beam melting show a columnar crystalline microstructure, wherein the average grain aspect ratio (GAR; ratio of grain length to grain width) in the build direction is typically greater than 8. An intercrystalline network of cracks, which reproduces the melting trace of the laser/electron beam, is formed in the plane perpendicular to the build direction. The cracks are predominantly intercrystalline hot and cold cracks. These cracks are partially interconnected, with the result that components often exhibit open porosity and are not impervious to gases and liquids. Stress resulting in fracture of the component generally is not accompanied by plastic deformation, and predominantly intercrystalline fracture behavior is observed. Intercrystalline fracture behavior is understood as meaning a fracture caused predominantly by cracks along the grain boundaries. As a result of this fracture behavior, components produced in this way exhibit low fracture resistance, low fracture toughness and low ductility.

Components made of molybdenum, tungsten and molybdenum- and tungsten-based alloys and produced by beam-based additive manufacturing processes typically have an oxygen content of between 0.25 and 0.6 at %. Where mechanically alloyed powders are used, the oxygen contents may also be markedly higher, at 2 at % and above. The oxygen content is not reduced, or is reduced insufficiently, by the beam-based additive manufacturing process, such as selective laser or electron beam melting, for example. When high-resolution investigation processes are employed, such as scanning or transmission electron microscopy, for example, it is found that the oxygen is precipitated predominantly at the grain boundaries, in the form of molybdenum/tungsten oxide, in prior-art components. These precipitates are arranged flatly at the grain boundaries and are responsible for the intercrystalline fracture behavior with consequently low fracture resistance and fracture toughness of additively manufactured components made of molybdenum, tungsten and alloys thereof. The high oxygen content means that both hot cracks and cold cracks can form. Hot cracks are formed during production as a result of reduced grain boundary strength. In the present case, in the heat-affected zone of the melting trace, the grain boundary strength is adversely affected by the melting of the oxides precipitated at the grain boundaries. Cold cracks are attributable to thermally induced stresses in combination with defects (pores, microcracks), which act as crack nuclei. If the grain boundary strength, then, is markedly lower than the strength in the grain interior, as is the case with the prior art, an intercrystalline cracking profile is present.

Moreover, a high oxygen content also exacerbates the balling effect. The oxygen accumulates in the edge region of the melting zone, where it reduces the surface tension. Accordingly, through Marangoni convection, a flow of material from the edge region into the center of the melting zone is promoted, thereby further markedly intensifying the balling triggered by the Plateau-Rayleigh instability.

WO 2019/068117 A1 describes the production of a component having a solid structure by an additive manufacturing process with a very low oxygen content.

WO 2020/102834 A1 teaches the possibility of establishing grain refinement by means of heterogeneous nucleation. However, since all of the ceramic phases having a melting point higher than that of the molybdenum/tungsten matrix material dissolve in the melt at thermodynamic equilibrium, the ceramic phase contents are inevitably very high, and so dissolution is incomplete in the molten phase with the times available, and a nucleating effect is achieved.

An additive manufacturing process for producing a component having a solid structure from a near-eutectic Mo—Si—B alloy is described in D. Fichtner et al. (Intermetallics 128 (2021) 107025, https://doi.org/10.1016/j.intermet.2020.107025). A further component having a solid structure which comprises a dendritic microstructure, consisting of an Mo—Si—B alloy, is shown in S. K. Makineni et al. (Acta Materialia 151 (2018) 31, https://doi.org/10.1016/j.actamat.2018.03.037). Silicon in Mo—Si—B alloys causes molybdenum embrittlement to a high degree, since silicon dissolves in molybdenum, leads to solid solution strengthening and hence has a severe embrittling effect. The brittleness is exacerbated by the molybdenum silicides and molybdenum silicon borides that form.

It is an object of the invention to provide a generic component in which the problems discussed above are avoided, a generic additive manufacturing process for reliably reducing a component having the aforementioned properties, and a powder which displays optimized behavior for use in an additive manufacturing process. An object of the invention more particularly is to provide a component which additionally exhibits improved ductility.

This object is achieved by a component having the features of claim 1, an additive manufacturing process having the features of claim 11, a powder having the features of claim 12, and a use of a powder having the features of claim 13. Advantageous embodiments of the invention are defined in the dependent claims.

A component of the invention possesses a solid structure consisting of an alloy which comprises as a main component a refractory metal from the group of molybdenum and tungsten (below, the refractory metal from the group of molybdenum and tungsten is abbreviated to RM) and as a further component boron (abbreviated to B) and optionally carbon (abbreviated to C), wherein the solid structure is manufactured via laser or electron beam in an additive manufacturing process and the solid structure comprises regions composed of the RM or of a solid solution of the RM and these regions are at least partially bounded by (RM)₂B, where B in the (RM)₂B may be replaced in part by C. If the main component is molybdenum, there is preferential formation of Mo₂B; if the main component is tungsten, there is preferential formation of W₂B; and if the main components are molybdenum and tungsten, there is preferential formation of (Mo, W)₂B. Extensive trials have shown that boron may be partially replaced by carbon and that (RM)₂(B,C) also has the inventive activity. The preferred content of carbon in this case is less than 5 at %, preferably less than 2 at %, especially preferably less than 1 at %. The ratio (in atomic percent) of boron to carbon here is preferably greater than 1:9, more preferably greater than 1:1, especially preferably greater than 8:1.

An additive manufacturing process of the invention for producing a component having a solid structure, more particularly a component of the invention, comprises at least the following steps:
providing a starting powder composed of a material which comprises as a main component a refractory metal from the group of molybdenum and tungsten (RM) and as a further component boron (B) and optionally carbon (C);
producing the solid structure by layer-wise fusing of the particles of the starting powder via laser or electron beam, with an energy such that the solid structure comprises regions composed of the RM or of a solid solution of the RM and these regions are at least partially bounded by (RM)₂B, where B may be replaced in part by C.

A powder of the invention consists of a material which comprises as a main component a refractory metal from the group of molybdenum and tungsten (RM) and as a further component boron (B) and optionally carbon (C), wherein the content of further alloy elements is less than 10 at %, preferably less than 5 at %, more particularly less than 1 at %.

The invention relates to the addition of boron in a preferred concentration range from 0.08 at % to eutectic composition, preferably 0.5 at % to 10 at %, more particularly 2 at % to 5 at %, more preferably 2 to 3.5 at %, to molybdenum, tungsten or an alloy of these metals. In the case of molybdenum, the eutectic composition occurs at 23 at %, and in the case of tungsten at 27 at %, of boron. The powder here may be an alloyed powder, a partly alloyed powder or a mixture. Further processing takes place by way of a beam-based additive manufacturing method (preferably selective laser beam melting or selective electron beam melting).

The addition of boron in the case of molybdenum and tungsten and in the context of processing by beam-based additive manufacturing processes has the effect of preventing cracks and increasing the density. On solidification, the microstructure becomes more refined, owing to the effect of constitutional supercooling. As a result, the area of the grain boundaries and sub-grain boundaries is significantly increased and the specific coverage of segregated impurities, especially oxygen, is reduced. In addition, there is a reduction in oxygen, allowing grain boundary cracks to be avoided. These effects induced by addition of boron are achieved in both tungsten-based and molybdenum-based alloys.

In usage, components produced additively from this material offer the advantage that the fine-grain microstructure results in significantly improved mechanical properties. At the same time the grain aspect ratio is reduced, leading to isotropic component properties.

The regions of the refractory metal or of a solid solution of the refractory metal that are at least partially bounded by (RM)₂B are preferably part of a predominantly cellular microstructure.

In a particularly suitable form, the boron may be added in the form of a boron-containing compound. Compounds of boron with an element from group 2, 3, 4 and 5 and also carbon have proven particularly suitable.

It is advantageous if boron is added in combination with a strong oxide former.

It is particularly advantageous if the compound partner in the boron-containing compound has little or no solubility in molybdenum, tungsten or the alloy of these metals. This is the case for the borides of the rare earth metals. LaB₆ (lanthanum hexaboride) may be highlighted as an example here. During the melting operation, the added LaB₆ is dissociated at least partially, preferably predominantly, in the metal melt. The effect of lanthanum is to reduce the formation of molybdenum/tungsten oxides, especially at the grain boundaries, in that the oxygen is offered a more attractive reactant than molybdenum/tungsten, in the form of the reductive alloy element lanthanum. The oxygen is therefore present at least partially in the form of very fine lanthanum oxide particles, which exert no adverse influence on the properties.

The alloy preferably contains a rare earth metal, preferably lanthanum, where the rare earth metal content is preferably 0.01 to 3 at %. Lanthanum here is present preferably at least partially in metallic form.

The component may contain oxygen, which is present at least partially in solution in the (RM)₂B.

An oxygen content is preferably less than 0.4 at %, more preferably less than 0.2 at %, very preferably less than 0.1 at %.

With preference, the collective content of the alloy elements, not including the refractory metal and boron contents, is less than 10 at %, preferably less than 5 at %, more particularly less than 1 at %.

With preference, the collective content of the elements from the group of Al, Si and Ge in the alloy is less than 0.5 at %. These elements have an embrittling effect, especially if they occur in solution in the refractory metal solid solution or as an intermetallic compound.

The component produced by way of a beam-based additive manufacturing process preferably achieves properties as follows:
relative density >98.0%, more preferably >99.5%
transcrystalline fracture behavior
average grain aspect ratio (GAR; ratio of grain length to grain width) in build direction <8, more preferably <5
flexural strength >600 MPa, more preferably >800 MPa

In the production of the component of the invention, atomic boron is present in dissolved form in the melt, and the refractory metal boride which is detectable in the solid structure forms in the course of solidification. The presence of the atomic boron in the melt produces an effect of constitutional supercooling, leading to a predominantly cellular microstructure.

By comparison with the prior art, the invention results in a greater ductility by virtue of the fine-grained nature that is established in the solid structure, and because oxygen contained in the component is preferably bound at least partially in the regions composed of (RM)₂B.

A molybdenum-based alloy is understood as meaning an alloy containing at least 50 at % of molybdenum. A molybdenum-based alloy more particularly comprises at least 80, 90, 95 or 99 at % of molybdenum. A tungsten-based alloy contains at least 50 at % of tungsten. A tungsten-based alloy more particularly comprises at least 80, 90, 95 or 99 at % of tungsten. A molybdenum-tungsten alloy is understood as meaning an alloy which comprises at least 50 at % of molybdenum and tungsten in total, more particularly at least 80, 90, 95 or 99 at % of molybdenum and tungsten in total. Molybdenum-tungsten alloys are a preferred embodiment in all concentration ranges.

With preference, W, Mo or a W/Mo solid solution is a main constituent of the solid structure.

It is preferable when the individual powder particles are melted by means of an additive manufacturing process, it being advantageous to use SLM (selective laser beam melting) or SEBM (selective electron beam melting).

The component is preferably built up layer-by-layer. For example, a powder layer is applied to a baseplate by means of a powder coater. The powder layer generally has a height of 10 to 150 micrometers.

In SEBM, a defocused electron beam is initially used to sinter the powder particles to one another so as to render them conductive. The powder is then locally melted by input of energy (via electron beam). SLM allows local melting of the powder by energy input (via laser beam) to be commenced immediately.

The beam generates a linear melting trace pattern having a line width of typically 30 micrometers to 200 micrometers. The laser or electron beam is guided over the powder layer. By suitable beam guidance, the entire powder layer or else just part of the powder layer can be melted and subsequently solidified. The melted and solidified regions of the powder layer are part of the finished component. The unmelted powder is not a constituent of the component produced. Subsequently, a further powder layer is applied by powder coater and the laser or electron beam is again guided over this powder layer. This results in a layer-wise build and a characteristic component structure. The guiding of the electron or laser beam results in formation of a so-called scan structure in each powder layer. In addition, a typical layer structure is likewise formed in the build direction, which is determined by the application of a new powder layer. Both the scan structure and the individual layers are apparent in the finished component.

The microstructure of powder particles fused selectively to form a solid structure by means of a high-energy beam (preferably a laser beam or electron beam) via an additive manufacturing process differs distinctly from a microstructure produced by means of other processes, for example thermal spraying. Thus thermal spraying comprises accelerating individual spray particles in a gas stream and flinging them onto the surface of the component to be coated. The spray particles may be in the fully or partially melted form (plasma spraying) or solid form (cold gas spraying). Layer formation occurs since the individual spray particles flatten upon impacting the component surface, remain adhering primarily through mechanical interengagement, and build up the spray layer layer-wise. A sheetlike layer structure is formed in this case. Layers produced in such a way exhibit in a plane parallel to the build direction a grain extent perpendicular to the build direction with an average grain aspect ratio (GAR; ratio of grain length to grain width) well above 2 and thus differ distinctly from layers/components produced by selective laser or electron beam melting, which in a plane parallel to the build direction likewise have an average grain aspect ratio well above 2, but with a grain extent parallel to the build direction.

In relation to the use of a powder in accordance with the invention, the powder preferably has a particle size of less than 100 micrometers.

Production of the powder may comprise pelletizing and optionally spheroidizing in addition, preferably in plasma, for example.

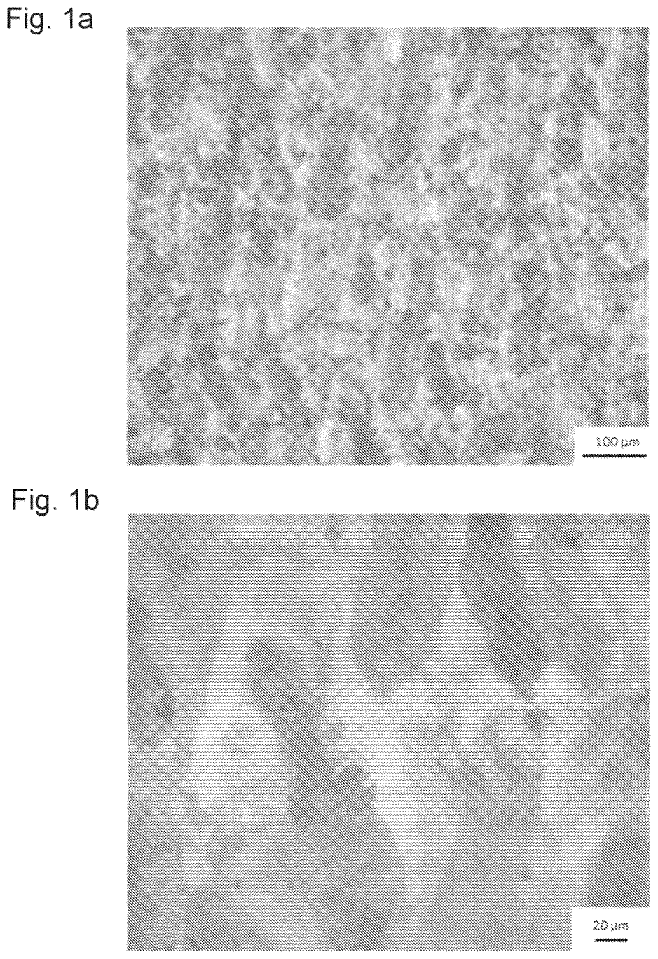

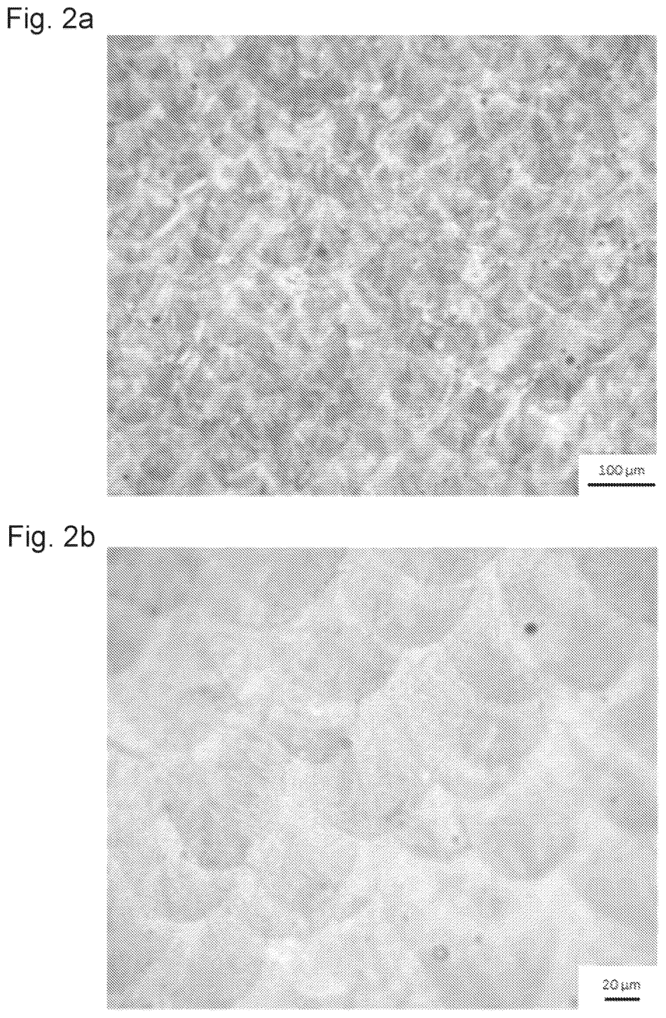

FIGS. 1 and 2 show the result of metallographic investigations of a sample according to the invention.

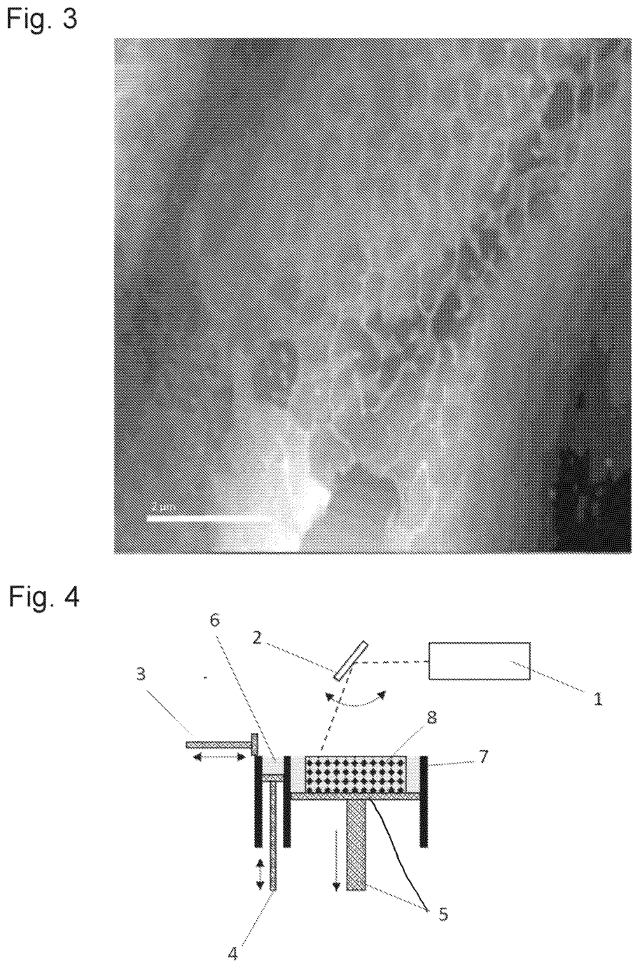

FIG. 3 shows the result of TEM/EDX investigations of a sample according to the invention.

FIG. 4 shows the SLM procedure schematically.

Samples according to the invention were produced by adding 1.5% by weight of LaB₆ powder of grading fraction <1 μm to spherical molybdenum powder of grading fraction <40 μm. The powder mixture was subsequently homogenized. The chemical and physical powder properties are set out in table 1.

TABLE 1

| Chemical composition | Bulk density/Tapped density |
|---|---|
| La: 0.66 at % | 5.3 g/cm³ |
| B: 4.3 at % | 5.8 g/cm³ |
| O: 0.1 at % | |
| Balance Mo and other impurities | |

The powder mixture was processed using the parameters typical for SLM volume construction of molybdenum, at a baseplate temperature of 800° C. (sample 1) and 500° C. (sample 2). The samples for microstructure characterization and determination of density had dimensions of 10 mm×10 mm×10 mm. The flexural samples had a size of 35 mm×5 mm×5 mm.

The metallographic investigation shows that all of the samples according to the invention are crack-free, as documented in FIG. 1a, FIG. 1b, FIG. 2a and FIG. 2b illustratively for sample 1 on the basis of light micrographs (plane of section perpendicular to the SLM build direction in FIG. 1a and FIG. 1b; plane of section parallel to the SLM build direction in FIG. 2a and FIG. 2b).

The microstructure is fine-grained with an average grain size of 8 μm. The average cell size is 0.7 μm. The average ratio of grain width to grain length is 1:2.5.

The results of the chemical analysis, the 3-point bending test and the evaluation of the fracture area are set out in table 2.

TABLE 2

| | | | 3-Point | Proportion of |
|---|---|---|---|---|
| | | | flexural | trans- |
| | | | strength | crystalline |
| | | | (test force | fracture |
| | | | parallel | (fracture |
| | | | to the | area parallel to |
| Sample | Chemical | Sample | LPBF build | the build |
| number | composition | density | direction) | direction) |
| 1 | La: 0.11 at % | 10.1 g/cm³ | 1200 MPa | >95% |
| | B: 3.56 at % | | | |
| | O: 0.05 at % | | | |
| | Balance Mo | | | |
| | and other | | | |
| | impurities | | | |
| 2 | La: 0.11 at % | 9.9 g/cm³ | 1150 MPa | >95% |
| | B: 3.34 at % | | | |
| | O: 0.06 at % | | | |
| | Balance Mo | | | |
| | and other | | | |
| | impurities | | | |

The flexural strength of the samples according to the invention is higher by a factor of about 10 than that of the sample according to the prior art. The fracture profile is trans-crystalline in all samples according to the invention.

The TEM/EDX investigations, represented illustratively for sample 2 in FIG. 3, show a cellular sub-grain structure which is formed of molybdenum (dark regions in FIG. 3) and Mo₂B (light-colored regions in FIG. 3). Lanthanum is present in the microstructure both elementally in the form of precipitates having a size of <50 nm and bound in the form of La₂O₃ precipitates having a size of <50 nm. No accumulations of oxygen were detectable at the grain boundaries.

The SLM procedure is represented schematically in FIG. 4. A control system exerts control over elements including the laser 1, the laser mirror 2, the powder coater 3, the powder supply line 4 from a powder reservoir vessel 6, and the position of the baseplate 5 in the build chamber 7. The system has build chamber heating. For the trials, the Mo baseplate was heated to 500° C. Using the powder coater 3, a powder layer was applied. The laser beam, guided by means of the laser mirror 2, scanned over the powder layer and, as it did so, melted the particles and, partially, the underlying layer already melted and solidified, melting taking place at the locations where material is present according to component design (component 8). The baseplate 5 was then lowered by 30 micrometers and the powder coater 3 applied a further powder layer, and the process sequence started over.

1-13. (canceled)

14. A component, comprising:
a solid structure consisting of an alloy which comprises, as a main component, a refractory metal (RM) selected from the group consisting of molybdenum and tungsten and, as a further component, boron (B) and optionally carbon (C);
said solid structure having the characteristics of having been manufactured additively via laser beam or electron beam; and
said solid structure having regions composed of the RM or of a solid solution of the RM and said regions being at least partially bounded by (RM)₂B, where B in the (RM)₂B may be replaced in part by C.

15. The component according to claim 14, wherein said alloy contains a rare earth metal, with a rare earth metal content of 0.01 to 3 at %.

16. The component according to claim 15, wherein said rare earth metal is lanthanum.

17. The component according to claim 14, further containing oxygen, which is at least partially in solution in the (RM)₂B.

18. The component according to claim 14, wherein a content of B lies in a range from 0.08 at % to eutectic composition.

19. The component according to claim 18, wherein the content of B lies in a range from 2 at % to 3.5 at %.

20. The component according to claim 14, wherein a collective content of the alloy elements, not including the contents of RM and B, is less than 10 at %.

21. The component according to claim 20, wherein the collective content of the alloy elements is less than 1 at %.

22. The component according to claim 14, wherein a collective content of elements selected from the group consisting of aluminum, silicon, and germanium in the alloy is less than 0.5 at %.

23. The component according to claim 15, wherein the rare earth metal is in metallic form.

24. The component according to claim 14, wherein the regions composed of the RM or of the solid solution of the RM and at least partially bounded by (RM)₂B are part of a predominantly cellular microstructure.

25. The component according to claim 24, wherein a mean cell size of the cellular microstructure is less than 2 micrometers and more than 0.01 micrometer.

26. The component according to claim 24, wherein the cellular microstructure has cell walls that are formed at least partially of (RM)₂B.

27. The component according to claim 14, wherein the component has an average grain aspect ratio (GAR; ratio grain length/grain width) in a build direction of less than 8.

28. The component according to claim 27, wherein the average grain aspect ratio in the build direction is less than 5.

29. The component according to claim 14, wherein the component has a fine-grained microstructure with an average grain size of 8 μm.

30. An additive manufacturing process for producing a component having a solid structure, the method comprising:
providing a starting powder composed of a material that contains, as a main component, a refractory metal (RM) selected from the group consisting of molybdenum and tungsten and, as a further component boron (B) and optionally carbon (C);
producing the solid structure by layer-wise fusing of the particles of the starting powder via laser beam or electron beam, with an energy to form the solid structure with regions composed of the RM or of a solid solution of the RM and the regions being at least partially bounded by (RM)₂B, where B in the (RM)₂B may be replaced in part by C.

31. A powder, comprising:
a main material component of a refractory metal (RM) selected from the group consisting of molybdenum and tungsten; and
a further material component being boron (B) and optionally carbon (C), with a content of further alloy elements being less than 10 at %.

32. The powder according to claim 31, wherein the content of the further alloy elements is less than 1 at %.

33. The method according to claim 30, which comprises producing the component according to claim 14 by an additive manufacturing process with a starting the starting powder having:
a main material component of a refractory metal (RM) selected from the group consisting of molybdenum and tungsten; and
a further material component being boron (B) and optionally carbon (C), with a content of further alloy elements being less than 10 at %.
